(19) United States
(12) Patent Application Publication
(10) Pub. No.: US 2005/0257238 A1
(43) Pub. Date: Nov. 17, 2005

(54) In-home receiver system

(75) Inventor: Pieter Werner Hooijmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/507,197

(22) PCT Filed: Feb. 12, 2003
(86) PCT No.: PCT/IB03/00613

§ 371 Date: Sep. 9, 2004

(30) Foreign Application Priority Data
Mar. 14, 2002 (EP) 02076033.6

(51) Int. Cl. H04N 7/18

(52) U.S. Cl. 725/78

(57) ABSTRACT

The in-home system comprises a complex main receiver (MR) and at least one standard receiver (AR). The main receiver (MR) receives the broadcast signals (HFIS) from the provider(s) and demodulates and/or decodes and/or descrambles (DEM) the broadcast signals (HFIS). A modulator (MOD) re-modulates the demodulated and/or decoded broadcast signals (MIS) onto a high-frequency carrier and provides this modulated signal (HFOS) to the standard receiver (AR). The demodulating, decoding, and/or descrambling (DEM) needs to be performed by the main receiver (MR) only, and is distributed via a high-frequency link to the standard receiver (AR) in the home environment. The main receiver (MR) comprises at least one tuner (TUi) with a tuner input (TUIi) for receiving the high-frequency input signal (HFIS) and a tuner output (TUOi) for supplying a tuner output signal (TOSi). A test signal generator (TSG) of the main receiver (MR) supplies a test signal (TSi) to the modulator (MODi) to obtain the high-frequency output signal (HFOSi). A directing circuit (DIR) directs the high-frequency output signal (HFOSi) to the tuner input (TUIi), and a test evaluator (TE) evaluates whether the tuner output signal (TUOi) is in conformance with the test signal (TSi). In this way, the performance of the system is checked.

### FIELD OF THE INVENTION

The invention relates to an in-home receiver system, a main receiver for use in such an in-home receiver system, and a method of testing such an in-home receiver system.

### BACKGROUND OF THE INVENTION

In present audio and/or video receiver set-up's, it becomes more and more important to be able to receive many different broadcast systems. Besides the terrestrial or satellite analog television signals transmitted by air or supplied on the cable, digital broadcasting becomes more popular. Also, data exchange between the provider and the user of the receiver is becoming more important.

Usually, present systems are upgraded to receive these new broadcasts by adding a separate set-top box to the television receiver. Also, television receivers are appearing on the market which incorporate the functionality of the set-top box. In the following, receiver refers to a set-top box receiver, a television receiver, an audio receiver or any other receiver for receiving audio and/or video broadcast signals.

The receiver may comprise a plurality of tuners, for example, a tuner for receiving the standard analog broadcast signals, a tuner for receiving digital broadcast signals, and a tuner for out-of-band or for example DOCSIS signaling. The out-of-band signaling may be based on the same protocols as used in internet cable modems, and may provide an up-stream channel to the provider, or internet access.

The receiver further comprises a demodulator and/or decoder which generates the base band signal. The base band signal, for example, may be an analog CVBS signal, an audio signal, or an MPEG data stream, or a decoded MPEG data stream.

For the further in-home re-distribution of the signals, a modulator of the receiver modulates the base band signal on a high-frequency carrier such that the modulated signal can be received by a standard analog tuner, which, for example, is available in another television receiver or a video recorder in the home.

The performance of the receiver may be negatively influenced by its increasing complexity.

### SUMMARY OF THE INVENTION

It is an object of the invention to provide provisions in the receiver for testing the performance of the receiver.

A first aspect of the invention provides an in-home receiver system with a main receiver and at least one further receiver, the main receiver comprising: at least one tuner with a tuner input for receiving a high-frequency input signal and a tuner output for supplying a tuner output signal, at least one modulator for receiving a modulator input signal to supply a high-frequency output signal to the at least one further receiver, a test signal generator for supplying a test signal to the at least one modulator, a directing circuit for directing the high-frequency output signal to the tuner input, and a test evaluator for evaluating whether the tuner output signal is in conformance with the test signal.

A second aspect of the invention provides a main receiver for use in an in-home system as claimed in claim 14. A third aspect of the invention provides a method of testing a main receiver of an in-home system as claimed in claim 15. Advantageous embodiments are defined in the dependent claims.

The in-home system comprises a main receiver and at least one further receiver further referred to as auxiliary receiver.

The main receiver receives the broadcast signals from the provider(s) and demodulates and/or decodes and/or descrambles the broadcast signals. A modulator re-modulates the demodulated and/or decoded and/or descrambles broadcast signals onto a high-frequency carrier and provides this modulated signal, or this modulated signal combined with the analog broadcast signal to the standard auxiliary receiver. The demodulating, decoding, and/or descrambling needs to be performed by the main receiver only, and is distributed via a high-frequency link to other receivers in the home environment. These other receivers do not need the demodulating, decoding, and/or descrambling functionality.

The main receiver comprises at least one tuner with a tuner input for receiving a high-frequency input signal and a tuner output for supplying a tuner output signal. Usually, the high-frequency input signal is the broadcast signal received from the provider, but it might be an in-home generated signal, for example by a portable audio-visual apparatus transmitting the audio and/or video information at a frequency in a high-frequency band (in the literature also referred to as RF-band, which is, for example, a radio broadcast band (for example, the FM-band), or a television band (for example, the UHF-band).

A test signal generator of the main receiver supplies a test signal to the modulator to obtain a high-frequency output signal. A directing circuit directs the high-frequency output signal to the tuner input, and a test evaluator evaluates whether the tuner output signal is in conformance with the test signal. The result of this conformance test may then be communicated to the set controller/micro-processor/etc. via e.g. a digital bus or a signaling line indicating PASS or FAIL.

In this manner, it is possible to test the performance of the main receiver. For example, it is possible to check whether the tuner and the modulator are still functioning, or whether the modulator still provides the intended carrier frequency.

The main receiver may comprise several tuners and modulators. In a complex system, the test provision becomes even more interesting, as will become clear from the embodiments of the invention as claimed from claim 6 onwards.

In an embodiment of the invention as claimed in claim 2, the directing circuit comprises a switch for supplying either the high-frequency input signal or the high-frequency carrier (also referred to as the high-frequency output signal from the modulator) to the tuner input under control of a switching signal generated by a switch control circuit of the main receiver.

In an embodiment of the invention as claimed in claim 3, the directing circuit comprises a series arrangement of a high-frequency coupler and a switch being controlled by a switching signal generated by a switch control circuit. The series arrangement is arranged between the tuner input and an output of the modulator to supply either the high-frequency input signal when the switch is open or the high-frequency input signal together with the high-frequency output signal to the tuner input when the switch is closed.

The commonly known passive high-frequency coupler couples the high-frequency signal at its input to another high-frequency signal.

In an embodiment of the invention as claimed in claim 4, the test signal is an analog signal which comprises a sine wave at a predetermined frequency, or the test signal is digital signal which comprises a bit sequence. In general, the test signal will be selected to be suitable to test the modulator and tuner under test.

In an embodiment of the invention as claimed in claim 5, the test signal generator comprises a modulator frequency controller which controls the at least one modulator to vary a frequency of the high-frequency output signal through a desired frequency band. This enables to check whether the tuner or tuners are still able to receive the broadcasts within the desired frequency band.

In an embodiment of the invention as claimed in claim 6, the in-home system comprises a plurality of tuners, each with a tuner input for receiving a high-frequency input signal and a tuner output for supplying a tuner output signal. A selector selects one of the plurality of tuners. A test evaluator produces a conformance signal if the output signal of the selected one of the tuners is in conformance with the test signal. The selector further selects another one of the plurality of tuners if the conformance signal indicates that the output signal of the selected one of the tuners is in not in conformance with the test signal.

All the tuners can be tested by checking whether the output signal is in conformance with the test signal modulated by the modulator on the high-frequency carrier. If it is detected that one of the tuners does not function properly, this can be brought to the attention of the user or a repair technician.

In an embodiment of the invention as claimed in claim 7, the controller comprises a tuner controller which controls one tuner (or more tuners, if required) to scan through at least part of the high-frequency band to be received. The scan may be performed through the complete band or through part of the band. A detector detects at which frequencies in the high-frequency band a broadcast signal is present and a frequency setting circuit sets a modulation frequency of the modulator or the modulators to interleave with the frequencies in the least part of the high-frequency band at which a broadcast signal is present.

The scan provides information on which channels a broadcast signal is present. The modulator(s) will be controlled to modulate the high-frequency signal in channels which are not occupied by broadcast signals. This automatic system has the advantage that the user does not need to adjust the modulators manually to an optimal frequency. Often, this difficult process leads to a non-optimal operation of the system because the modulators are not adjusted carefully enough and interferences occur.

The automatic system in accordance with this embodiment of the invention may perform additional tests on the suitability of the channel selected for the modulator. For example, the modulator may supply a non-modulated carrier only, the signal at the tuner output is an indication whether any interference occurs.

In an embodiment of the invention as claimed in claim 8, a timing circuit causes the test signal to be supplied at regular time intervals. In this manner, it is possible to take changes into account. By regularly checking the presence of broadcast signals in the band, a modulator frequency can be adjusted if a channel appears to be used by a new broadcast or by a broadcast which occupies a channel during a predetermined period of the day only. Further it is possible to compensate for drift of the modulator frequency, for example due to aging.

In an embodiment of the invention as claimed in claim 9, the main receiver comprises a plurality of tuners with respective tuner inputs which receive the high-frequency input signal and which have respective tuner outputs for supplying tuner output signals.

An input terminal is available to connect an input coaxial cable which supplies the high-frequency input signal with a broadcast signal. A first high-frequency splitter splits the signal on the input coaxial cable into a plurality of signals which are supplied as the high-frequency input signals to the tuner inputs.

A high-frequency demodulator circuit receives the tuner output signals to supply respective demodulated or decoded video signals, which for example are a CVBS signal or a QPSK or QAM modulated MPEG data stream, to modulate them on a high-frequency carrier wave.

A plurality of modulators receive the respective modulator input signals and supply the high-frequency output signals to a high-frequency combiner which combines the high-frequency output signals into a plurality of combined high-frequency output signals. A first combined high-frequency output signal is supplied to a first auxiliary receiver via a first output coaxial cable. A second combined high-frequency output signal is supplied to a second auxiliary receiver via a second output coaxial cable. If more auxiliary receivers are present, the combiner has to supply more combined high-frequency output signals.

Preferably, the modulator input signals are the demodulated or decoded video signals. This allows the auxiliary receivers to be simple as they do not require the extra demodulators and decoders (and descramblers if applicable). It is possible to supply the tuner output signals (which may be analog or digital (for example, an MPEG stream)) to the demodulators. This is especially relevant for the signals which do not require special demodulators or decoders in the auxiliary receivers.

A test signal generator supplies the test signal to at least one of the modulators, the directing circuit directs a combined high-frequency output signal to an input of a combiner which combines this combined high-frequency output signal with the high-frequency input signal. A test evaluator evaluates whether the tuner output signal is, or the signals are, in conformance with the test signal. The test evaluator may communicate the outcome of the test to a microcontroller of the receiver. The microcontroller takes the required action, for example, warns the user that the receiver does not operate properly.

In an embodiment of the invention as claimed in claim 10, the combiner is a high-frequency coupler coupled to the input coaxial cable. A second high-frequency splitter is coupled to the first mentioned high-frequency coupler for supplying the high-frequency input signal to a second high-frequency coupler and a third high-frequency coupler, the second high-frequency coupler is coupled to the first output coaxial cable and a third high-frequency coupler is coupled to the second output coaxial cable. In this manner, the signal on the input coaxial cable is looped through to the output coaxial cables and is directly available to the auxiliary receivers.

In an embodiment of the invention as claimed in claim 11, the main receiver comprises a high-frequency switching matrix which is able to connect any high-frequency input to any high-frequency output. It is also possible to connect the same input or output to several outputs or inputs, respectively (a so-called broadcast mode).

The switching matrix has inputs for receiving the high-frequency input signal from the high-frequency splitter, the high-frequency output signals of the modulators. The switching matrix has outputs to supply the high-frequency input signals to the tuner inputs, and the high-frequency output signals to the high-frequency combiner.

The tuner output signals are supplied to the demodulator and the test signal generator and need not be directed via the high-frequency switching matrix. The test signals are supplied to the modulator inputs as the modulator signals and also need not be directed via the high-frequency switching matrix.

This switching matrix has the advantage that it can be incorporated much more easily and effectively, and thus cheaper in an integrated circuit, this contrary to the high-frequency combiners. A further advantage is that the loop-through from the signal on the input coaxial to the output coaxial cables can be performed by the switching matrix. Now, it can also be checked whether this loop-through function is performing correctly.

In an embodiment of the invention as claimed in claim 12, the high-frequency switching matrix further has an input to receive the high-frequency output signal. This enables to check a double path through the switching matrix.

In an embodiment of the invention as claimed in claim 13, the main receiver further comprises a circuit for adding an upstream signaling stream onto the high-frequency input signal. This enables communication to the provider, which is important when applications like video-on-demand or internet are required.

Especially if the cable set-top box receiver will merge into a digital home server box, multiple channels have to be received and re-distributed throughout the house, further increasing the number of tuners. Since most in-house networks will for a long time continue to be based on coaxial cables, on the transmitter side increasing numbers of high-frequency modulators will be needed.

The in-home system comprises a main receiver and at least one further receiver. The main receiver receives the broadcast signals from the provider(s) and demodulates and/or decodes the broadcast signals. A modulator re-modulates the demodulated and/or decoded broadcast signals onto a high-frequency carrier and provides this modulated signal or this decoded signal combined with the analog broadcast signal to the standard further receiver. The standard further receiver need not be able to process the signals (for example, digital television, MPEG streams, internet data) which the main receiver is able to process into base band signals.

These and other aspects of the invention are apparent from and will be elucidated with reference to the embodiments described hereinafter.

### BRIEF DESCRIPTION OF THE DRAWINGS

In the drawings:

FIG. 1 shows a block diagram of an embodiment of a system in accordance with the invention,

FIG. 2 shows an embodiment of a directing circuit of the system,

FIG. 3 shows another embodiment a directing circuit of the system,

FIG. 4 shows an embodiment of a controlling circuit of the system,

FIG. 5 shows another embodiment of a controlling circuit of the system,

FIG. 6 shows a block diagram of an embodiment of a main receiver of the system in accordance with the invention, and

FIG. 7 shows a block diagram of another embodiment of a main receiver of the system in accordance with the invention.

### DETAILED DESCRIPTION OF THE PREFERRED EMBODIMENT

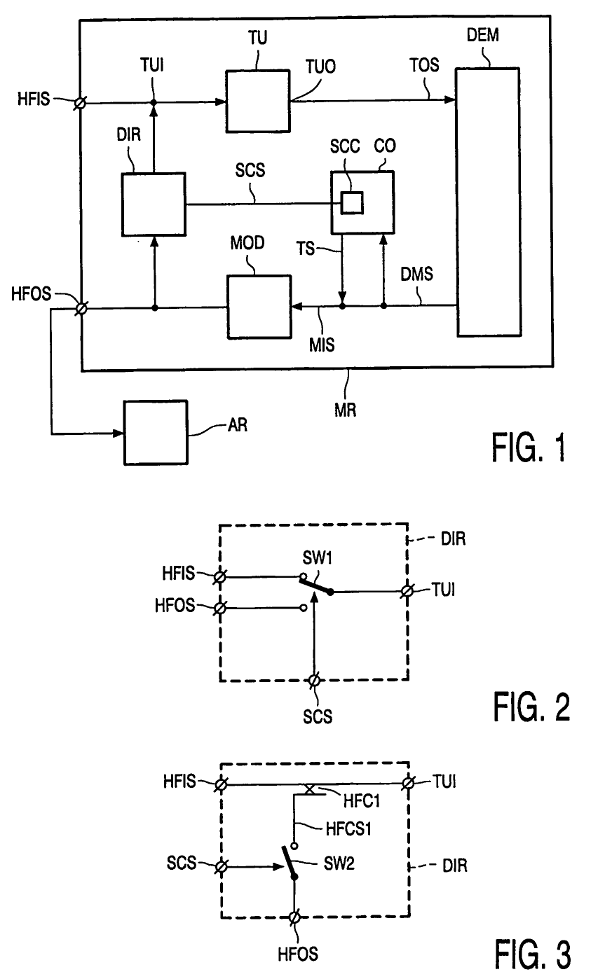

FIG. 1 shows a block diagram of an embodiment of a system in accordance with the invention. The system comprises a main receiver MR and an auxiliary receiver AR.

The main receiver MR comprises a tuner TU, a controller CO, a modulator MOD, a demodulator DEM, and a directing circuit DIR.

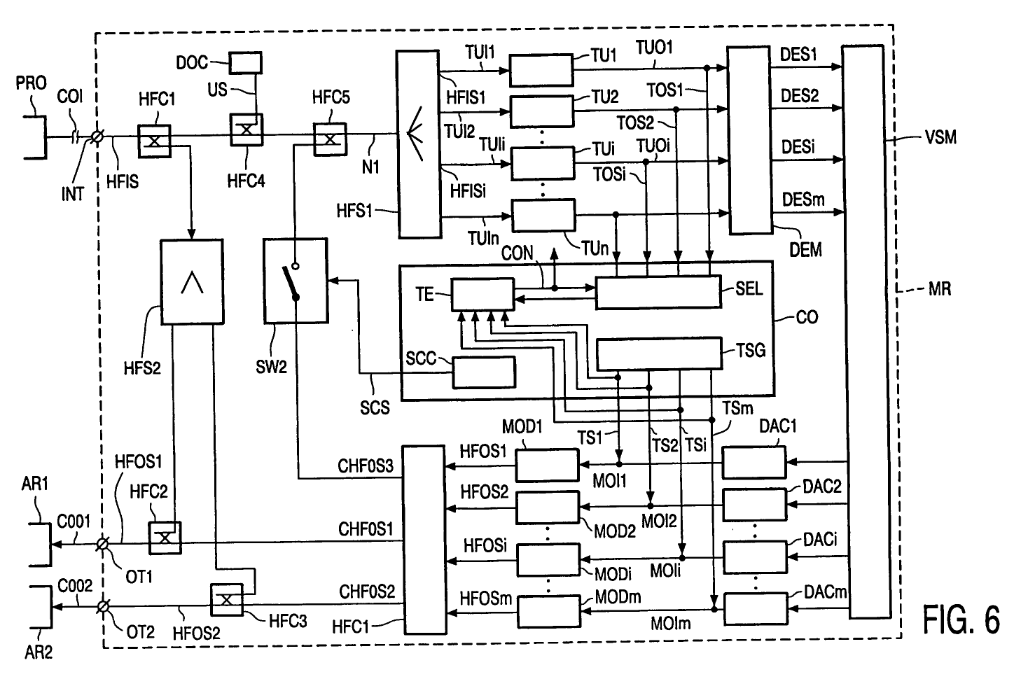

The tuner TU has an input TUI at which a high-frequency input signal HFIS of a broadcast is received and a tuner output TUO at which a low frequent tuner output signal TOS is supplied. Usually, the high-frequency input signal HFIS is supplied by an input coaxial cable COI (shown in FIG. 6). Usually, the tuner output signal TOS is a base band audio and/or video signal which may be encoded or which may be a composite signal such as a CVBS signal.

The demodulator DEM receives the tuner output signal TOS and supplies a demodulated and/or decoded signal DMS suitable to be displayed on a display screen of the main receiver MR.

The modulator MOD has an input to receive a modulator input signal MIS and an output to supply a high-frequency output signal HFOS to the auxiliary receiver AR. Usually, the modulator input signal MIS is the demodulated and/or decoded signal DMS. The high-frequency output signal HFOS is supplied to the auxiliary receiver AR via a coaxial cable in a frequency range and with a modulation type suitable for a standard available broadcast receiver. The auxiliary receiver AR usually is able to receive analog broadcast channels as transmitted in the VHF and the UHF bands. This set-up allows using standard available auxiliary receivers AR which need not be adapted to be able to receive and demodulate or decode the broadcast signal which is processed by the tuner TU and the demodulator DEM of the main receiver MR. The tuner TU and the demodulator DEM, for example, may process a digital video signal which is MPEG coded. Usually, the main receiver MR comprises a further tuner to receive the standard analog broadcast channels.

The controller CO generates a test signal TS which is supplied to the input of the modulator MOD and a switching signal SCS which is supplied to the directing circuit DIR. The controller CO receives the demodulated signal DMS, or the tuner output signal TOS. The switching signal SCS is supplied by a switch control circuit SCC of the controller CO.

The directing circuit DIR has an input to receive the high-frequency output signal HFOS and an output to supply the high-frequency output signal HFOS to the input TUI of the tuner TU.

The main receiver MR has a first mode wherein the high-frequency input signal HFIS is processed to be displayed, and a test mode wherein the controller CO provides the test signal TS to the modulator MOD. The modulator MOD modulates the test signal on a high-frequency carrier to obtain the high-frequency output signal HFOS. The directing circuit DIR couples the high-frequency output signal HFOS to the input TUI of the tuner TU under control of the switching signal SCS. The controller CO receives the demodulated signal DMS which is the demodulated test signal, and compares the demodulated test signal with the generated test signal TS to determine whether the main receiver MR is performing correctly. The controller CO may take an appropriate action or may output a signal to a micro-controller if an incorrect performance is detected.

FIG. 2 shows an embodiment of a directing circuit of the system.

The directing circuit DIR comprises a switch SW1 controlled by the switching signal SCS which is generated by the switch control circuit SCC of the controller CO. A first input terminal of the switch SW1 receives the high-frequency input signal HFIS, a second input terminal of the switch SW1 receives the high-frequency output signal HFOS from the modulator MOD, and the common terminal of the switch SW1 is connected to the tuner input TUI. In the normal receiving mode the control signal SCS causes the switch to supply the high-frequency input signal HFIS to the tuner input TUI. In the test mode, the control signal SCS causes the switch to supply the high-frequency output signal HFOS to the tuner input TUI.

FIG. 3 shows another embodiment a directing circuit of the system.

The directing circuit DIR comprises a high-frequency coupler HFC1 and a switch SW2. The high-frequency coupler HFC1 and the switch SW2 are arranged in series between the output of the modulator MOD and the input TUI of the tuner TU.

The high-frequency coupler HFC1 couples the input signal HFCS1 to the high-frequency input signal HFIS, usually with an insertion loss. Such a coupler is well known in the art.

The switching signal SCS which is generated by the switch control circuit SCC of the controller CO controls the switch SW2 to be open in the normal receiving mode and to be closed in the test mode.

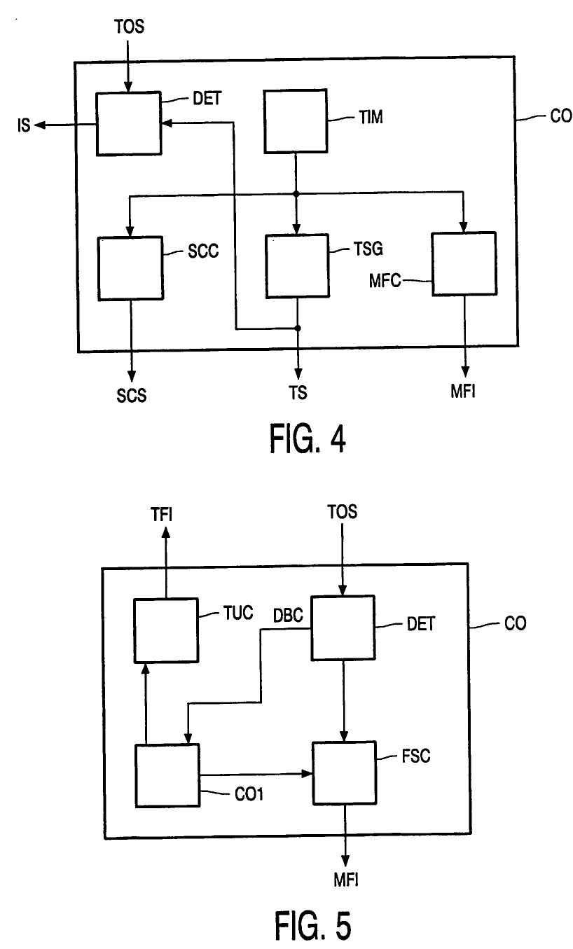

FIG. 4 shows an embodiment of a controlling circuit of the system. The controller CO comprises a test signal generator TSG, a timing circuit TIM, a modulator frequency controller MFC, a detector DET, and the switch control circuit SCC.

The test signal generator TSG generates the test signal TS. The test signal TS may be analog or digital. A suitable analog test signal TS may be a sine wave with a fixed frequency or with a varying frequency and with a fixed or varying amplitude. The digital test signal TS may be a bit sequence which may be digitally modulated. The test signal TS will be modulated on a high-frequency carrier by the modulator MOD.

The modulator frequency controller MFC supplies a modulator frequency control signal MFI to the modulator MOD to control the channel frequency of the high-frequency output signal HFOS. The modulator frequency controller MFC may vary a frequency of the high-frequency output signal HFOS through a desired frequency band.

The controlling circuit CO further comprises a detector DET which receives the tuner output signal TOS, compares the received tuner signal TOS with the test signal TS and outputs an indication signal IS to indicate the outcome of the test. This enables to check whether the tuner TU (or tuners TUi if the main receiver comprises more than one tuner) is still able to receive the broadcasts within the desired frequency band.

The timer TIM may control the test signal generator TSG to provide the test signal TS at regular intervals or at certain occasions such as the first time the receiver is switched on every day. For example, it may be regularly tested whether the modulator MOD still produces the correct channel frequency, and to correct a shift if it is detected. This allows to compensate for drift of the modulator frequency, for example due to aging. The timer TIM further controls the switch control circuit SCC to couple the high-frequency output signal HFOS to the tuner input TUI during the test mode, and the frequency controller MFC to provide a desired frequency or frequency sweep.

It is possible to use the test signal generator TSG during production of the main receiver only, especially if it has only to be tested if all the tuners TUi and all the modulators MODi function correctly.

FIG. 5 shows another embodiment of a controlling circuit of the system. The controller CO comprises a tuner controller TUC, a detector DET, a frequency setting circuit FSC, and a controller CO1.

The controller CO1 controls the tuner controller TUC to supply a tuner frequency control signal TFI to control the tuner TU (or more tuners TUi, if required) to scan through at least part of the high-frequency band to be received by the main receiver MR. The scan may be performed through the complete band or through part of the band.

The detector DET receives the tuner output signal TOS to detect at which frequencies in the high-frequency band a broadcast signal is present, and provides this information DBC to the controller CO1.

The controller CO1 controls a frequency setting circuit FSC to supply a modulator frequency setting signal to the modulator MOD to set a modulation frequency of the modulator MOD (or the modulators MODi) to interleave with the frequencies in the least part of the high-frequency band at which a broadcast signal is present.

The scan provides information on which channels a broadcast signal is present. The modulator MOD will be controlled to modulate the high-frequency output signal HFOS in channels which are not occupied by broadcast signals. This automatic system has the advantage that the user does not need to adjust the modulators manually to an optimal frequency. Often, this difficult process leads to a non-optimal operation of the system because the modulators are not adjusted carefully enough and interferences occur.

The timer TIM as shown in FIG. 4 may also be used in the controller CO shown in FIG. 5. By regularly checking the presence of broadcast signals in the band, a modulator frequency can be adjusted if a channel appears to be used by a new broadcast or by a broadcast which occupies a channel during a predetermined period of the day only.

The embodiments of FIG. 4 and FIG. 5 may be combined.

FIG. 6 shows a block diagram of an embodiment of a main receiver of the system in accordance with the invention.

The main receiver MR receives the high-frequency input signal HFIS from a provider PRO via an input coaxial cable at an input terminal INT. The main receiver MR supplies a high-frequency output signal HFOS1 at the output terminal OT1 via an output coaxial cable COO1 to an auxiliary receiver AR1 and a high-frequency output signal HFOS2 at an output terminal OT2 via an output coaxial cable COO2 to an auxiliary receiver AR2.

The main receiver MR comprises a plurality of tuners TU1 to TUn and a plurality of modulators MOD1 to MODm. A particular tuner is denoted by TUi, and a particular modulator is denoted by MODi. Each of the tuners TUi has a tuner input TUIi to receive a high-frequency input signal HFISi and a tuner output TUOi to supply a low frequent tuner output signal TOSi.

A high-frequency splitter HFS1 has an input connected to a node N1 and supplies the tuner input signals TUIi to the tuners TUi.

The demodulator DEM demodulates or decodes the tuner output signals TOSi into demodulator output signals DESi (usually base band signals). In FIG. 6 some of the demodulator output signals DESi are digital signals.

A video switching matrix VSM receives the demodulator output signals DESi and supplies the modulator input signals MOIi to the modulators MODi. The video switching matrix VSM selects the signal to be displayed on the main receiver, and selects which output signal DESi is directed to which modulator MODi. The output signals DESi are converted by digital to analog converters DACi into the analog modulator input signals MOIi.

A high-frequency combiner HFC1 combines the high-frequency output signals HFOSi of the modulators MODi into three combined high-frequency signals CHFOSi. The combined high-frequency signal CHFOS1 is supplied to the output terminal OT1 via a high-frequency coupler HFC2, the combined high-frequency signal CHFOS2 is supplied to the output terminal OT2 via a high-frequency coupler HFC3, and the combined high-frequency signal CHFOS3 is supplied to the switch SW2.

A high-frequency coupler HFC1, a high-frequency coupler HFC4, and a high-frequency coupler HFC5 are arranged between the input terminal INT and the node N1 in this order.

The high-frequency coupler HFC1 supplies the input signal at the input terminal INT to a splitter HFS2. The splitter HFS2 supplies the input signal at the input terminal INT to the output terminal OT1 via a high-frequency coupler HFC2 which acts as a combiner. The splitter HFS2 supplies the input signal at the input terminal INT to the output terminal OT2 via a high-frequency coupler HFC3 which acts as a combiner. Consequently, the high-frequency input signal HFIS is linked through to the auxiliary receivers AR1 and AR2. These signals need not be modulated on a carrier by the modulators MODi.

The high-frequency coupler HFC4 acts as a combiner to add the upstream signal US to the high-frequency input signal HFIS. The upstream signal US may be a DOCSIS signal generated by a DOCSIS upstream signaling circuit DOC.

The high-frequency coupler HFC5 acts as a combiner which adds the high-frequency output signal HFOS to the input signal during the test mode.

The directing circuit DIR comprises the switch SW2 and the combiner HFC5. It is also possible to use the directing circuit DIR shown in FIG. 2.

The main receiver MR further comprises a controller CO which receives the tuner output signals TUOi (or the demodulator output signals DESi, not shown in FIG. 6) and supplies the test signals TSi to the modulators MODi. The controller CO supplies the switching signal SCS to the switch SW2 such that the combined high-frequency output signal CHFOS3 is supplied to the coupler HFC5 in the test mode only.

The controller comprises a test signal generator TSG which generates the test signals TSi, a selector SEL which selects one of the tuner output signals TOSi, and a test evaluator TE which tests whether the selected tuner output signal TOSi is in conformance with the test signal TSi. The test evaluator TE supplies a conformance signal CON to the selector SEL to indicate whether the selected tuner output signal TOSi is in conformance with the test signal TSi. If conformance is detected, the circuit loop from test signal TSi via modulator MODi, splitter HFC1, switch SW2, coupler HFC5, splitter HFS1 and tuner TUi is operating correctly. If no conformance is detected, the selector selects another one of the tuners TUi, and the conformance test is repeated. The conformance signal CON may be outputted to indicate the status of the test to, for example, the user via a microcontroller. The conformance signal CON may be provided on a digital output bus.

Due to the controller CO and the directing circuit DIR in accordance with the invention, it is possible to test a significant part of the main receiver MR. Further, if the controller comprises the tuner controller TUC, the detector DET, and the frequency setting circuit FSC shown in FIG. 5, it is possible to automatically set the modulator frequencies of the modulators MODi such that they do not coincident with the frequencies of the channels in which a broadcasting is present. This may improve the performance of the system which comprises the main receiver MR and the auxiliary receivers AR1 and AR2 considerably by avoiding interferences between the present broadcasts and the modulator frequencies.

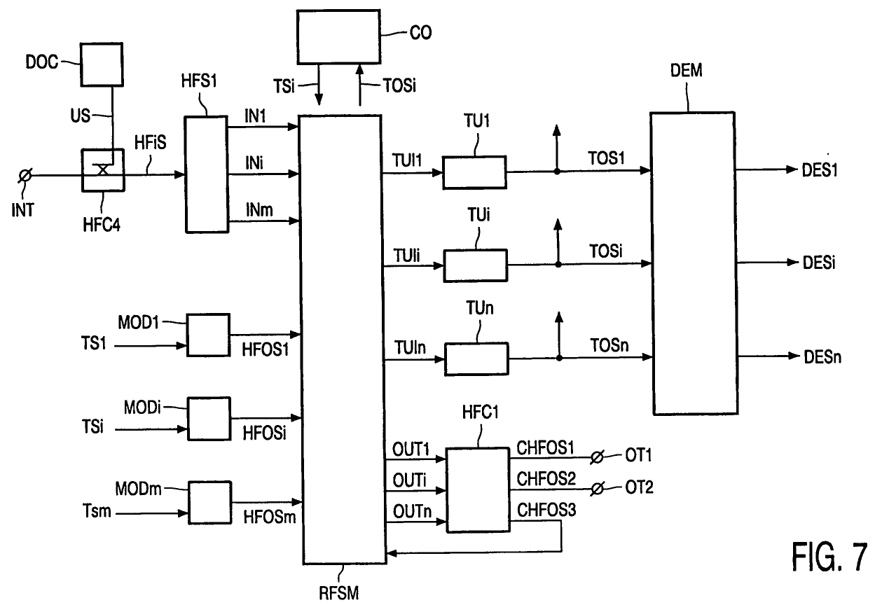

FIG. 7 shows a block diagram of another embodiment of a main receiver of the system in accordance with the invention.

The main receiver MR comprises a high-frequency switching matrix RFSM which is able to connect any of its inputs INi or the signals HFOSi to any of its outputs OUTi or to any of the tuner inputs TUIi. It is also possible to connect the same input INi or output OUTi to several outputs OUTi or inputs INi, respectively.

The switching matrix RFSM has inputs INi for receiving the high-frequency input signal HFIS from the high-frequency splitter HFS1, and inputs for receiving the high-frequency output signals HFOSi of the modulators MODi

The switching matrix RFSM has outputs OUTi to supply the high-frequency input signals HFSI to the tuner inputs TUIi, the high-frequency output signals HFOSi to the high-frequency combiner HFC1.

The test signals TSi from the controller CO are supplied to the respective modulators MODi. The tuner output signals TOSi are supplied to the demodulator DEM and to the controller CO. Instead of the tuner output signals TOSi, it is also possible to supply the demodulator output signals DESi to the controller CO.

The input of the expander HFS1 is connected to the input terminal via the combiner HFC4 which adds the upstream signal US from the upstream signaling circuit DOC. This enables communication to the provider, which is important when applications like video-on-demand or internet are required.

The combiner HFC1 generates the combined high-frequency signals CHFOSi. The combined high-frequency signal CHFOS1 is supplied to the output terminal OT1, and the combined high-frequency signal CHFOS2 is supplied to the output terminal OT2.

The combined high-frequency signal CHFOS3 is supplied to an input of the high-frequency switching matrix RFSM. This enables to check a double path through the switching matrix. For example, it is possible to create a path from the modulator MODn, via a matrix input INi, a matrix output OUTj to matrix input INk and matrix output OUT1 to the tuner TU1 (the indices are an example only). Now, two paths trough the matrix RFSM are involved and the information is obtained about the performance of the matrix RFSM.

This switching matrix RFSM has the advantage that it can be incorporated in an integrated circuit much more efficiently and cost-effective, this contrary to the high-frequency combiners which are because of this mostly discrete components. A further advantage is that the loop-through from the signal on the input terminal INT to the output terminals OT1 and OT2 can be performed by the switching matrix RFSM. Now, it can be checked also whether this loop-through function is operating correctly.

It should be noted that the above-mentioned embodiments illustrate rather than limit the invention, and that those skilled in the art will be able to design many alternative embodiments without departing from the scope of the appended claims. For example, instead of the high-frequency couplers

In the claims, any reference signs placed between parenthesis shall not be construed as limiting the claim. The word “comprising” does not exclude the presence of other elements or steps than those listed in a claim. The invention can be implemented by means of hardware comprising several distinct elements, and by means of a suitably programmed computer. In the device claim enumerating several means, several of these means can be embodied by one and the same item of hardware.

1. An in-home receiver system with a main receiver and at least one further receiver,
the main receiver comprising:
at least one tuner with a tuner input for receiving a high-frequency input signal and a tuner output for supplying a tuner output signal,
at least one modulator for receiving a modulator input signal to supply a high-frequency output signal to the at least one further receiver,
a test signal generator for supplying a test signal to the at least one modulator,
a directing circuit for directing the high-frequency output signal to the tuner input, and
a test evaluator for evaluating whether the tuner output signal is in conformance with the test signal.

2. An in-home receiver system as claimed in claim 1, wherein
the main receiver further comprises a switch control circuit for supplying a switching signal to the directing circuit, and
the directing circuit further comprises a switch for supplying either the high-frequency input signal or the high-frequency output signal to the tuner input under control of the switching signal.

3. An in-home receiver system as claimed in claim 1, wherein
the main receiver further comprises a switch control circuit for supplying a switching signal to the directing circuit, and
the directing circuit further comprises a series arrangement of a high-frequency coupler and a switch being controlled by the switching signal, the series arrangement being arranged between the tuner input and an output of the modulator for supplying either the high-frequency input signal when the switch is open or the high-frequency input signal together with the high-frequency output signal to the tuner input when the switch is closed.

4. An in-home receiver system as claimed in claim 1, wherein the test signal comprises a sine wave at a predetermined frequency, or a bit sequence.

5. An in-home receiver system as claimed in claim 1, wherein the test signal generator comprises a modulator frequency controller for controlling the at least one modulator to vary a frequency of the high-frequency output signal through a desired frequency band.

6. An in-home receiver system as claimed in claim 1, wherein the in-home system comprises
a plurality of tuners, each with a tuner input for receiving a high-frequency input signal and a tuner output for supplying a tuner output signal,
a selector for selecting one of the plurality of tuner output signals,
a test evaluator for producing a conformance signal if the output signal of the selected one of the tuner output signals is in conformance with the test signal,
the selector further being arranged for selecting an other one of the plurality of tuner output signals if the conformance signal indicates that the output signal of the selected one of the tuners is in not in conformance with the test signal.

7. An in-home receiver system as claimed in claim 1, wherein the controller comprises
a tuner controller for controlling the at least one tuner to scan through at least part of the high-frequency band to be received,
a detector for detecting at which frequencies in the at least part of the high-frequency band a broadcast signal is present, and
a frequency setting circuit for setting a modulation frequency of the at least one modulator to interleave with the frequencies in the at least part of the high-frequency band at which a broadcast signal is present.

8. An in-home receiver system as claimed in claim 1, wherein the controller further comprises a timing circuit for supplying the test signal at regular time intervals.

9. An in-home receiver system as claimed in claim 1, wherein the main receiver comprises:
a plurality of tuners with respective tuner inputs for receiving the high-frequency input signal and respective tuner outputs for supplying tuner output signals,
an input terminal for connecting an input coaxial cable to supply the high-frequency input signal comprising a broadcast signal,
a first high-frequency splitter for supplying the high-frequency input signal to the tuner inputs,
a demodulator circuit for receiving the tuner output signals to supply respective demodulated or decoded video and/or audio signals,
a plurality of modulators coupled to the demodulator circuit for receiving respective modulator input signals to supply high-frequency output signals,
a first high-frequency combiner for combining the high-frequency output signals into a plurality of combined high-frequency output signals,
a first output terminal for supplying a first one of the plurality of combined high-frequency output signals to a first one of a plurality of auxiliary receivers via a first output coaxial cable,
a second output terminal for supplying a second one of the plurality of combined high-frequency output signals to a second one of the plurality of auxiliary receivers via a second output coaxial cable,
the test signal generator for supplying the test signal to at least one of the plurality of modulators,
the directing circuit for directing a third one of the plurality of combined high-frequency output signals to an input of the first high-frequency combiner, and
a test evaluator for evaluating whether tuner output signals are in conformance with the test signal.

10. An in-home receiver system as claimed in claim 9, wherein the main receiver further comprises:
a first high-frequency coupler coupled to the input coaxial cable,
a second high-frequency splitter coupled to the first high-frequency coupler for supplying the high-frequency input signal to a second high-frequency coupler and a third high-frequency coupler, the second high-frequency coupler being coupled to the first output coaxial cable and a third high-frequency coupler being coupled to the second output coaxial cable.

11. An in-home receiver system as claimed in claim 9, wherein the main receiver further comprises a high-frequency switching matrix having inputs for receiving the high-frequency input signal from the first high-frequency splitter, the high-frequency output signals of the modulators, the test signals of the test signal generator, and the tuner output signals, and having outputs to supply the high-frequency input signal to the tuner inputs, the high-frequency output signals to the first high-frequency combiner, and the test signals and/or the tuner output signals as the modulator input signal to the modulators.

12. An in-home receiver system as claimed in claim 11, wherein the high-frequency switching matrix further has an input for receiving the high-frequency output signal.

13. An in-home receiver system as claimed in claim 1, wherein the main receiver further comprises a circuit for adding an upstream signaling stream onto the high-frequency input signal.

14. A main receiver for use in the in-home receiver system as claimed in claim 1, and comprising:
at least one tuner with a tuner input for receiving the high-frequency input signal and a tuner output for supplying a tuner output signal,
at least one modulator for receiving a modulator input signal to supply a high-frequency output signal to the at least one further receiver,
a test signal generator for supplying a test signal to the at least one modulator,
a directing circuit for directing the high-frequency output signal to the tuner input, and
a test evaluator for evaluating whether the tuner output signal is in conformance with the test signal.

15. In an in-home system comprising:
at least one further receiver, and
a main receiver comprising at least one tuner with a tuner input for receiving a high-frequency input signal and a tuner output for supplying a tuner output signal, and at least one modulator for receiving a modulator input signal to supply a high-frequency output signal to the at least one further video receiver, a method of testing the main receiver comprising:
supplying a test signal to the at least one modulator,
directing the high-frequency output signal to the tuner input, and
evaluating whether the tuner output signal is in conformance with the test signal.
